(19) United States
(12) Patent Application Publication
(10) Pub. No.: US 2021/0263612 A1
(43) Pub. Date: Aug. 26, 2021

(54) INPUT DEVICE

(71) Applicant: OMRON Corporation, Kyoto-shi, KYOTO (JP)

(72) Inventors: Masayuki SHINOHARA, Nagaokakyo-shi (JP); Yasuhiro TANOUE, Kyoto-shi (JP); Norikazu KITAMURA, Osaka-shi (JP); Yuto MORI, Joyo-shi (JP)

(73) Assignee: OMRON Corporation, Kyoto-shi, KYOTO (JP)

(21) Appl. No.: 17/253,644

(22) PCT Filed: Mar. 11, 2019
(86) PCT No.: PCT/JP2019/009777

§ 371 Date: Dec. 18, 2020

(30) Foreign Application Priority Data
Jul. 10, 2018 (JP) 2018-131077

(51) Int. Cl. G06F 3/042; G02B 6/10; G02B 30/56; G06F 3/01

(52) U.S. Cl. CPC G06F 3/0421; G06F 3/016; G02B 30/56; G02B 6/10

(57) ABSTRACT

An input device according to one or more embodiments may include a light guide plate configured to direct light entering from a light source so that the light exits from a light emitting surface and forms an image in a space, the image being an object for an input action from a user; a sensor configured to detect an object employed by a user for the input action; an input detection unit configured to detect an input from a user on the basis of a detection result from the sensor for the object; and a notification unit configured to notify a user that the input was detected when the input detection unit has detected an input from a user. The sensor may be placed in a space opposite the light emitting surface of the light guide plate.

### FIELD

The present invention relates to an input device for forming an image in a space while detecting an input from a user with respect to said image.

### BACKGROUND

Existing input devices are known that form an image in a space by causing light to be emitted from the light emitting surface of a light guide plate while detecting an object positioned at the light emitting surface side of the light guide plate. Patent Document 1, for example, discloses a device for causing an image to form in a space and detecting an object in the space. This kind of device allows the user to perform an input action by virtually touching the floating image of a button stereoscopically displayed in a space.

### RELATED ART DOCUMENTS

### Patent Documents

[Patent Document 1] Japanese Patent Publication JP 2014-67071 A

### SUMMARY

### Technical Problem

However, the features disclosed in Patent Document 1 require the sensor for detecting input from a user to be installed more on the user side versus the light guide plate since the sensor is placed at the light emitting surface side of the light guide plate. Therefore, this created a problem where the space from the light guide plate toward the user was more complex.

One aspect of the present invention aims to achieve an input device capable of providing a simplified structure in the space from the light guide plate toward the user.

### Solution to Problem

To address the above-mentioned problems, an input device according to an aspect of the present invention includes a light guide plate configured to direct light entering from a light source so that the light exits from a light emitting surface and forms an image in a space, the image an object for an input action from a user; a sensor configured to detect an object employed by a user for the input action; an input detection unit configured to detect an input from a user on the basis of a detection result from the sensor for the object; and a notification unit configured to notify a user that the input was detected when the input detection unit has detected an input from a user; and the sensor is placed in a space opposite the light emitting surface of the light guide plate.

### Effects

One aspect of the present invention allows for a more simplified structure in the space from the light guide plate toward the user.

### BRIEF DESCRIPTION OF THE DRAWINGS

FIG. 1 is a side view of an input device according to a first embodiment of the present invention;

FIG. 2 is a block diagram of the input device;

FIG. 3 is a perspective view of a stereoscopic image display unit provided in the input device;

FIG. 4 is a diagram illustrating the input device before the input device accepts input from a user;

FIG. 5 is a diagram illustrating the appearance when the input device accepts input from a user;

FIG. 6 is a diagram illustrating a range in which the position detection sensor provided in the input device detects an object;

FIG. 7 is a block diagram illustrating the main constituents of the input device when the input device is used as a switch;

FIG. 8A and FIG. 8B are diagrams illustrating example configurations of an input device when the input device functions as an alternating switch;

FIG. 9A through FIG. 9E are for describing the operations of the input device;

FIG. 10 is a diagram illustrating one example of the input device;

FIG. 11 is a perspective view illustrating a configuration of a light guide plate as a modification example of the light guide plate provided in the input device;

FIG. 12 is a side view illustrating a configuration of an input device as a modification example of the input device;

FIG. 13 is a diagram for illustrating a structure of an input device as another modification example of the input device;

FIG. 14 is a diagram for illustrating a configuration of an input device as another modification example of the input device;

FIG. 15A and FIG. 15B are diagrams illustrating examples of a stereoscopic image formed by a stereoscopic image display unit provided in the input device;

FIG. 16 is a cross-sectional view illustrating a structure of a switch according to one aspect of the present invention;

FIG. 17 is a block diagram of an input device as another modification example of the input device;

FIG. 18 is a perspective view of a stereoscopic image display unit as a modification example of the stereoscopic image display unit in the first embodiment;

FIG. 19 is a cross-sectional view illustrating a configuration of the stereoscopic image display unit;

FIG. 20 is a plan view illustrating a configuration of the stereoscopic image display unit;

FIG. 21 is a perspective view illustrating a configuration of optical-path changing portions provided in the stereoscopic image display unit;

FIG. 22 is a perspective view illustrating a distribution of the optical-path changing portions;

FIG. 23 is a perspective view illustrating how a stereoscopic image is formed by the stereoscopic image display unit;

FIG. 24 is a perspective view of a stereoscopic image display unit as a modification example of the stereoscopic image display unit in the first embodiment;

FIG. 25 is a cross-sectional view illustrating a configuration of the stereoscopic image display unit; and

FIG. 26A and FIG. 26B are perspective views illustrating examples of a game machine wherein the above input device is adopted.

### DETAILED DESCRIPTION

### First Embodiment

An embodiment (below, “the embodiment”) according to an aspect of the invention is described below on the basis of the drawings. However, in all respects the embodiment described below is merely an example of the invention. It goes without saying that various modifications and variations are possible without departing from the scope of the invention. That is, specific configurations may be adopted as appropriate in accordance with the embodiment when implementing the invention.

### 1. Example Application

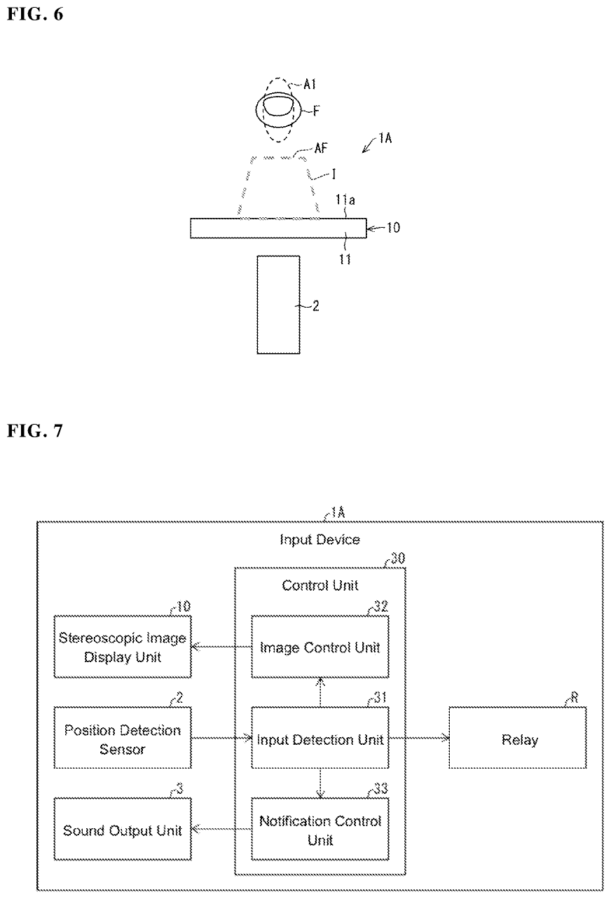

First, an example of where the present invention may be adopted is described using FIG. 6. FIG. 6 is a diagram illustrating the appearance when the input device 1A accepts input from a user.

An input device 1A of one aspect of the present invention can be adopted as an operation unit or a switch, or the like, in a machine, and accepts input with respect to said machine. As illustrated in FIG. 6, the input device 1A is provided with a stereoscopic image display unit 10, and a position detection sensor 2.

The stereoscopic image display unit 10 of the input device 1A forms the stereoscopic image I which is an object for an input action by a user as illustrated in FIG. 6. The stereoscopic image is a truncated trapezoid shape whose height coincides with the longitudinal direction (which is perpendicular to the light guide plate 11), and emulates a switch. The user performs an input action with respect to the input device 1A by moving a finger F toward the emission surface 11a of the light guide plate 11 in a direction perpendicular to the emission surface 11a and moving the finger F up to the front surface AF. The position detection sensor 2 is configured to detect an object that is in a range A1 in front of the front surface AF of the stereoscopic image I by a predetermined distance therefrom in a direction perpendicular to the emission surface 11a of the light guide plate 11.

As illustrated in FIG. 6, the position detection sensor 2 is placed in a space opposite the emission surface 11a of the light guide plate 11. Thus, it is possible to simplify the structure in the space from the light guide plate 11 toward the user since the position detection sensor 2 is placed opposite the emission surface 11a.

### 2. Example Configuration

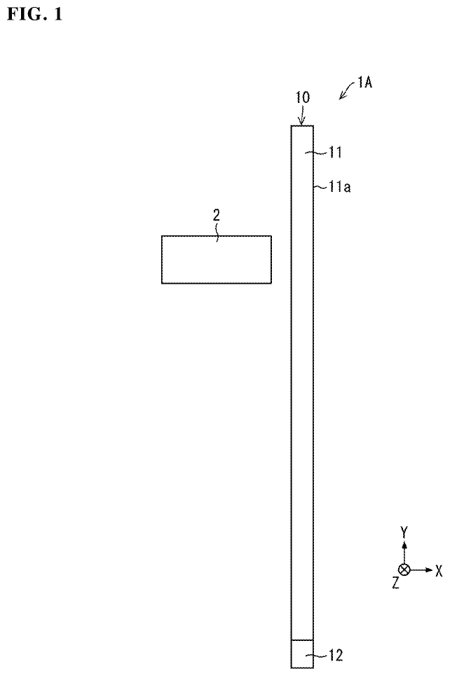

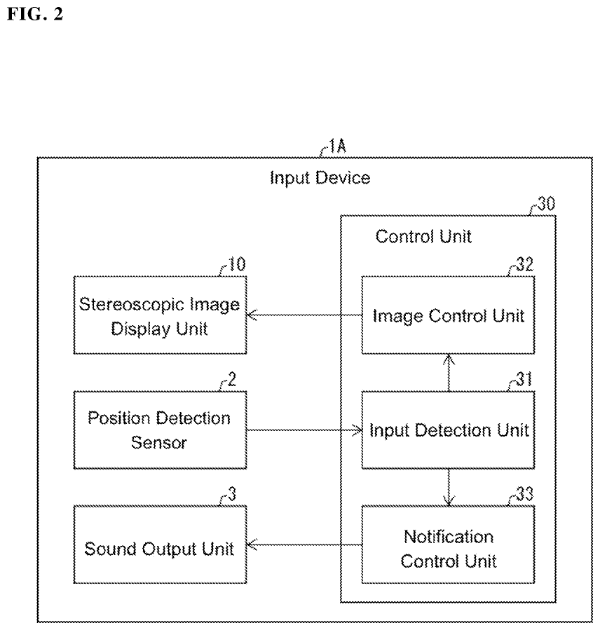

An example configuration of an input device of the present invention is described below with reference to the drawings. FIG. 1 is a side view of the input device 1A in the embodiment. FIG. 2 is a block diagram of the input device 1A.

As illustrated in FIG. 1 and FIG. 2, the input device 1A is provided with a stereoscopic image display unit 10, a position detection sensor 2 (sensor), a sound output unit 3 (sound output device), and a control unit 30. Note that for the sake of convenience, the description that follows refers to the positive X axis direction, the negative X axis direction, the positive Y axis direction, the negative Y axis direction, the positive Z axis direction, and the negative Z axis direction in FIG. 1, as forward, backward, upward, downward, rightward, and leftward, respectively. Note that the stereoscopic image display unit 10 and the position detection sensor 2 in this embodiment is stored inside a housing (not shown). However, the emission surface 11a of the light guide plate 11 (later described) is exposed from the above-mentioned housing.

The stereoscopic image display unit 10 forms a stereoscopic image I perceivable by the user in a space having no screen.

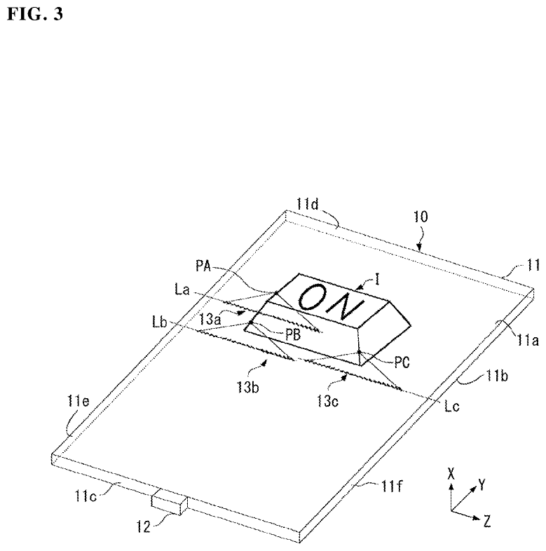

FIG. 3 is a perspective view of the stereoscopic image display unit 10. For the sake of convenience, FIG. 3 depicts the appearance of the stereoscopic image display unit 10 presenting a button-shaped stereoscopic image I (protruding in the positive X direction) showing the word “ON” as an example of the stereoscopic image I. As illustrated in FIG. 3, the stereoscopic image display unit 10 is provided with the light guide plate 11 and a light source 12.

The light guide plate 11 is a rectangular solid and is made of a transparent resin material having a relatively high refractive index. The light guide plate 11 may be produced from, for instance, a polycarbonate resin, a poly methyl methacrylate resin, glass or the like. The light guide plate 11 is provided with an emission surface 11a (i.e., a light emitting surface) that outputs light, a rear surface 11b (opposing surface) opposite the emission surface 11a, and four end surfaces 11c, 11d, 11e, 11f. The end surface 11c is an incidence surface whereat light projected from the light source 12 enters the light guide plate 11. The end surface 11d opposes the end surface 11c; and the end surface 11e opposes the end surface 11f. The light guide plate 11 guides light from the light source 12 such that the light spreads out in planar form in a plane parallel to the emission surface 11a. The light source 12 may be a light emitting diode (LED), for example. In the embodiment, the light guide plate 11 is arranged so that the emission surface 11a is parallel to a vertical direction. Note that in one aspect of the present invention the light guide plate 11 may be arranged so that the emission surface 11a is at a predetermined angle relative to the vertical direction.

A plurality of optical-path changing portions 13 are formed on the rear surface 11b of the light guide plate 11 including an optical-path changing portion 13a, an optical-path changing portion 13b, and an optical-path changing portion 13c. The optical-path changing portions are formed sequentially for the most part along the Z axis direction. In other words, the plurality of optical-path changing portions is formed along predetermined lines in a plane parallel to the emission surface 11a. Light projected from the light source 12 and directed by the light guide plate 11 is incident at each position of the optical-path changing portions along the Z axis direction. The optical-path changing portions cause light incident at each location thereof to substantially converge at a fixed point corresponding to the optical-path changing portion. The optical-path changing portion 13a, optical-path changing portion 13b, and optical-path changing portion 13c in particular are shown in FIG. 3 as one portion of the optical-path changing portions; the optical-path changing portion 13a, optical-path changing portion 13b, and optical-path changing portion 13c in particular are shown in a state where the plurality of light beams exiting therefrom converge.

More specifically, the optical-path changing portion 13a corresponds to a fixed point PA in the stereoscopic image I. Light exiting from each location of the optical-path changing portion 13a converges at the fixed point PA. Therefore, the optical wavefront from the optical-path changing portion 13a appears as an optical wavefront that is radiating from the fixed point PA. The optical-path changing portion 13b corresponds to a fixed point PB in the stereoscopic image I. Light exiting from each location of the optical-path changing portion 13b converges at the fixed point PB. Thus, any of the optical-path changing portions 13 cause light incident at each location thereof to substantially converge at a corresponding fixed point. Thus, any of the optical-path changing portions 13 may present an optical wavefront that appears to radiate from a corresponding fixed point. The optical-path changing portions 13 correspond to mutually different fixed points. The grouping of a plurality of fixed points corresponding to the optical-path changing portions 13 produces a stereoscopic image I in a space which can be perceived by a user. More specifically, the stereoscopic image I is produced in a space near the emission surface 11a in relation to the light guide plate 11.

As illustrated in FIG. 3, the optical-path changing portions 13a, 13b, and 13c are formed along the lines La, Lb, and Lc respectively. Here the lines La, Lb, and Lc are straight lines that are substantially parallel to the Z axis direction. Any given optical-path changing portion is formed sequentially for the most part along a straight line parallel to the Z axis direction.

Note that the light guide plate 11 preferably has a haze, which represents the ratio of total transmitted light to diffused light, of less than or equal to a predetermined numerical value (for example, less than or equal to 28%). Thus, the light from the position detection sensor 2 that illuminates the light guide plate does not diffuse or if the light does diffuse it is by a small amount.

The optical-path changing portions are provided with a reflection surface for reflecting light guided through the light guide plate 11 toward the emission surface 11a. The surface density of the reflection surface in relation to the rear surface 11b (in other words, the ratio of the surface area of the reflection surface to the surface area of the rear surface 11b when viewing the emission surface 11a from a perpendicular direction) is preferably less than or equal to 30%. Hereby, an object can be detected via detection light passing through the light guide plate 11 even when the position detection sensor 2 is provided in the space at the rear surface 11b.

The position detection sensor 2 is for detecting an object positioned in a space that includes the image forming location whereat the stereoscopic image I is formed by the stereoscopic image display unit 10. The position detection sensor 2 in the embodiment is a limited reflection sensor. The position detection sensor 2 is provided with a light emitting element (not shown) and a light receiving element (not shown). The light emitting element emits light, and the light receiving element receives light normally reflected from a detection object; hereby, the position detection sensor 2 detects an object positioned at a specific location. The position detection sensor 2 outputs the detection result to a later-described input detection unit 31.

The position detection sensor 2 is located behind the stereoscopic image display unit 10 (in the negative X axis direction) at a position in the vertical direction where the stereoscopic image I is formed. The position detection sensor 2 is placed in a space opposite the emission surface 11a of the light guide plate 11.

Note that, besides the limited reflection sensor, a different type of sensor may be used as the position detection sensor 2 in an input device of the present invention. One aspect of the present invention may use a time-of-flight sensor, proximity sensor, capacitive sensor, position sensor, or gesture sensor as the position detection sensor 2 in the input device; a sensor that combines a shell-type LED with a photodiode may also be used.

The sound output unit 3 receives an instruction from a notification control unit 33 (later described) and outputs a sound.

The control unit 30 performs overall control of the units in the input device 1A. The control unit 30 is provided with an input detection unit 31, an image control unit 32 (notification unit), and the notification control unit 33 (notification unit).

The input detection unit 31 detects an input from the user on the basis of the result of detection of an object by the position detection sensor 2. On detecting an input from a user, the input detection unit 31 outputs that information to the image control unit 32 and the notification control unit 33.

The image control unit 32 controls the stereoscopic image I that is presented by the input device 1A. More specifically, the image control unit 32 changes the image presented by the input device 1A when the image control unit 32 obtains information that the input detection unit 31 has detected an input from the user. The details hereof are described later.

The notification control unit 33 controls the operation of the sound output unit 3. More specifically, the notification control unit 33 outputs an instruction that directs the sound output unit 3 to output a sound when the notification control unit 33 obtains information that the input detection unit 31 has detected an input from the user.

### 3. Operation Example

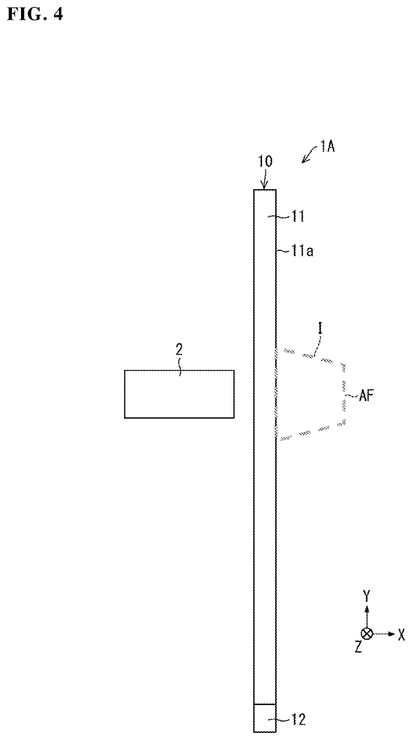

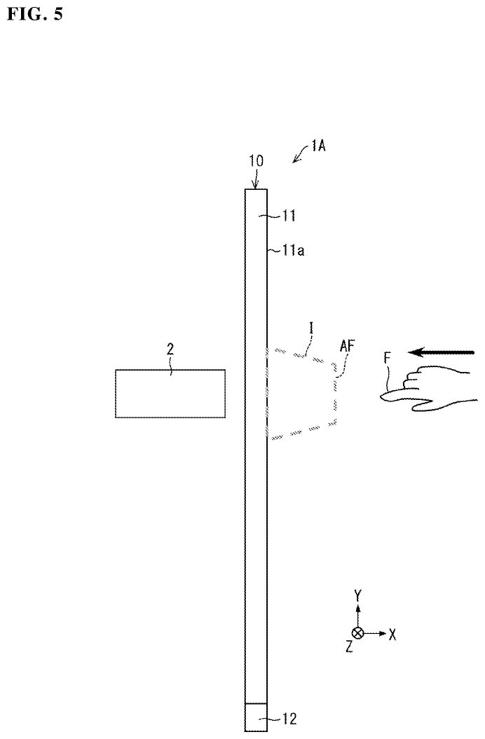

An example operation of the input device 1A is described next while referencing the drawings. FIG. 4 is a diagram illustrating the input device 1A before the input device accepts input from a user; and FIG. 5 is a diagram illustrating the appearance when the input device 1A is receiving an input from a user.

The image control unit 32 in the input device 1A controls the light source 12 in the stereoscopic image display unit 10 so that the light source is turned on while the input device 1A is waiting for an input from the user. Thus, the input device is in a state where the stereoscopic image I is formed as illustrated in FIG. 4. This operation example is used to describe a case where the stereoscopic image display unit 10 creates a stereoscopic image I that is a truncated trapezoid shape whose height coincides with the longitudinal direction (which is perpendicular to the light guide plate 11). In this example, the stereoscopic image emulates a switch. The surface in the stereoscopic image I that is furthest from the light guide plate 11 (i.e., the surface that is the top of the truncated trapezoid shape) is referred to hereafter as the front surface AF.

As illustrated in FIG. 4, the truncated trapezoid that is the stereoscopic image I is formed so that the height thereof is perpendicular to the emission surface 11a of the light guide plate 11. In this case, the user performs an input action with respect to the input device 1A by moving a finger F (the object) toward the emission surface 11a of the light guide plate 11 in a direction perpendicular to the emission surface 11a and moving the finger F up to the front surface AF as illustrated in FIG. 5.

FIG. 6 is a diagram illustrating a range A1 in which the position detection sensor 2 detects an object. As illustrated in FIG. 6, the position detection sensor 2 of the embodiment is configured to detect an object in a range A1 in front of the front surface AF of the stereoscopic image I by predetermined distance therefrom in a direction perpendicular to the emission surface 11a of the light guide plate 11. In other words, the position detection sensor 2 is configured to detect that the finger F is positioned along the direction the input action is performed by the user in a region a predetermined distance away from where the stereoscopic image I is formed in a direction opposite the direction the input action is performed.

The above configuration allows for the position detection sensor 2 to detect the user's finger F before the user's finger F reaches the stereoscopic image I. The position detection sensor 2 outputs information to the input detection unit 31 to the effect that the user's finger F was detected.

On obtaining information from the position detection sensor 2 to the effect that the user's finger was detected, the input detection unit 31 detects that the user entered an input with respect to the input device 1A. On detecting an input from the user, the input detection unit 31 outputs that information to the image control unit 32 and the notification control unit 33.

The image control unit 32 turns off the light source 12 in the stereoscopic image display unit 10 on obtaining information that an input from the user was detected. Thus, the stereoscopic image I is not formed. That is, the image control unit 32 alters the display state of the stereoscopic image I. The user is thereby notified that the input device 1A has accepted the operation performed with respect to the input device 1A.

Additionally, the notification control unit 33 instructs the sound output unit 3 to output a sound on obtaining information from the position detection sensor 2 to the effect that the user's finger was detected. The sound output unit 3 may output a sound, for instance, “Your input was received”, or the like. The user is thereby notified that the input device 1A has accepted the operation performed with respect to the input device 1A.

As above described, the position detection sensor 2 in the input device 1A is placed in a space opposite the emission surface 11a of the light guide plate 11. Thus, it is possible to simplify the structure in the space from the light guide plate 11 toward the user since the position detection sensor 2 is placed opposite the emission surface 11a.

Additionally, the light guide plate 11 is transparent as described above. Therefore, this facilitates transmission of the detection light for detecting the object from the position detection sensor 2 through the light guide plate 11.

Existing position detection sensors are configured to detect an input from the user by detecting that the user's finger is positioned at the location where the stereoscopic image is formed. This increases the time until the user recognizes that the input device detected the user's input action and in some cases creates a problem where the user queries whether the input device detected the input accurately.

In contrast, the position detection sensor 2 in the input device 1A of this embodiment is configured to detect an object in a range A1 in front of the stereoscopic image I by a predetermined distance in a direction perpendicular to the emission surface 11a of the light guide plate 11. Therefore, the user can be more quickly notified that the input device 1A accepted the input from the user. Thus, the user can be given a more satisfactory operational feel with respect to the input device 1A.

A survey of three subjects was conducted with regard to the operational feel of the input device 1A when the detection position of the position detection sensor 2 was established as in the following cases, (A) through (C).

(A) a range from where the stereoscopic image I is formed to in front of the stereoscopic image I by a predetermined distance in a direction perpendicular to the emission surface 11a of the light guide plate 11;

(B) an area where the stereoscopic image is formed; and

(C) a range from where the stereoscopic image I is formed to behind the stereoscopic image I by a predetermined distance in a direction perpendicular to the emission surface 11a of the light guide plate 11.

In the end, all the subjects responded that (A) provided the most operational feel, and (C) gave the least operational feel.

Note that the distance in the longitudinal direction between the front surface AF of the stereoscopic image I and range A1, which is the area where the position detection sensor 2 performs detection, is preferably 5 to 35 cm. Thus, the input device more reliably provides the user with an operational feel.

In this embodiment of the input device 1A, the position detection sensor 2 is configured to detect an object in a range A1 in front of the stereoscopic image I by a predetermined distance in a direction perpendicular to the emission surface 11a of the light guide plate 11; however, an input device according to the present invention is not limited hereto. That is, one aspect of the present invention may be configured so that the stereoscopic image I is formed at or near the location where the position detection sensor 2 detects the object that the user uses to perform the input action.

The input device 1A may be adopted as an input unit for a toilet seat with warm water bidet, an input unit for an elevator, a lighting switch for a vanity, an operation switch for a faucet, an operation switch for a range hood, an operation switch for a dishwasher, an operation switch for a refrigerator, an operation switch for a microwave, an operation switch for an induction cooktop, an operation switch for an electrolyzed water generator, an operation switch for an intercom, a corridor lighting switch, or an operation switch on a compact stereo system, or the like. Adopting the input device 1A as any of these kinds of input units or switches provided the benefit of: (i) facilitating cleaning given that there are no ridges or grooves on the input unit; (ii) improved design flexibility given that a stereoscopic image only needs to be presented at the required time; (iii) cleanliness, given that there is no need to touch a switch; and (iv) resistance to breakage given that there are no moving parts.

FIG. 7 is a block diagram illustrating the main constituents of the input device 1A when the input device 1A is used as a switch. As illustrated in FIG. 7, the input device 1A may be integrated with a relay R when the input device 1A is used as a switch. In the case where the input device 1A is used as a switch, the input device 1A may function as a momentary switch where the switch is in an on state while the position detection sensor 2 detects an object in the range A1. In this case, the input device 1A presents a stereoscopic image that shows that the switch is in the on state only while the position detection sensor 2 detects the object in the range A1. The input device 1A may also function as an alternating switch where the switch is in the on state when the position detection sensor 2 detects the object in the range A1; the switch remains in the on state thereafter when the position detection sensor 2 no longer detects the object in the range A1 and until the position detection sensor 2 once again detects an object in the range A1. In this case, the input device 1A presents a stereoscopic image showing that the switch is in the on state from the time the position detection sensor 2 detects the object in the range A1 until the position detection sensor 2 once again detects an object in the range A1. That is, the input device 1A is provided with a relay R and can be used as a switch by controlling the opening and closing of the relay R in accordance with the detection state of the input from the user detected by the input detection unit 31.

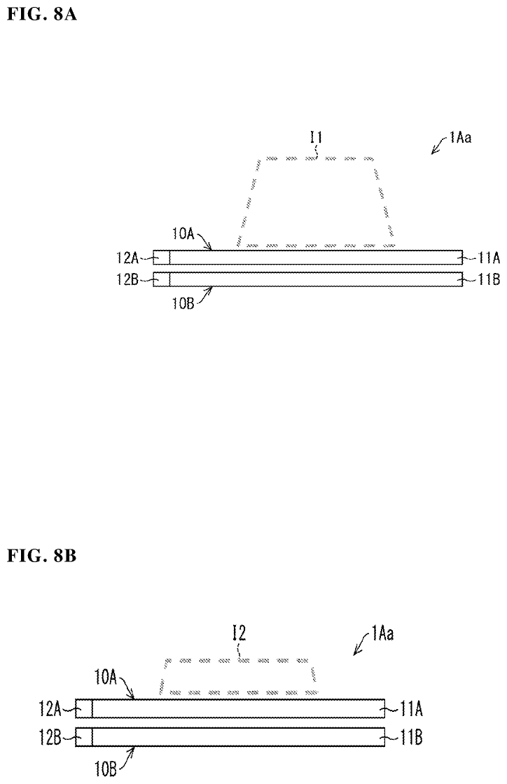

A configuration example is described for an input device 1Aa which functions as an alternating switch. FIG. 8A and FIG. 8B are diagrams illustrating example configurations of the input device 1Aa. As illustrated in FIG. 8A and FIG. 8B, the input device 1Aa is provided with two stereoscopic image display units 10. For the purpose of distinguishing the two stereoscopic image display units 10, the units are referred to as a stereoscopic image display unit 10A and a stereoscopic image display unit 101B, respectively. As illustrated in FIG. 8A and FIG. 8B, the stereoscopic image display unit 10A is provided with a light guide plate 11A and a light source 12A. The stereoscopic image display unit 10B is provided with a light guide plate 11B and a light source 12B. The stereoscopic image display unit 10A and the stereoscopic image display unit 10B are illuminated by the light source 12A and the light source 12B to thereby each create different stereoscopic images I1, I2.

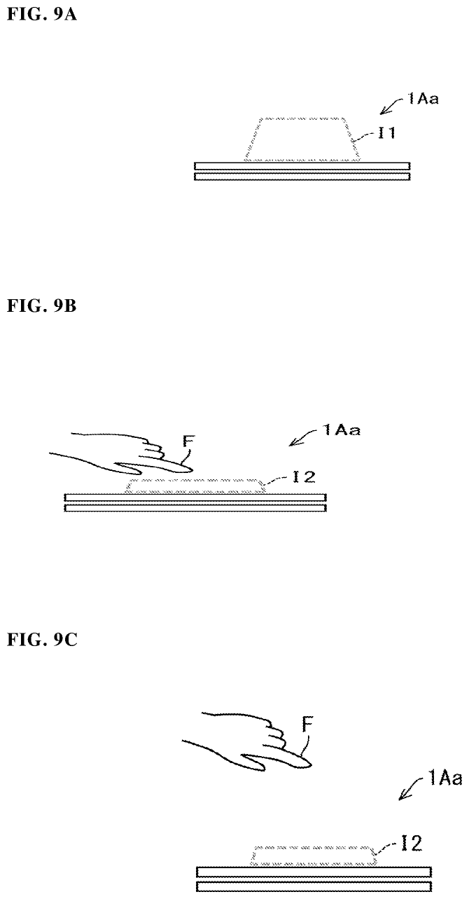

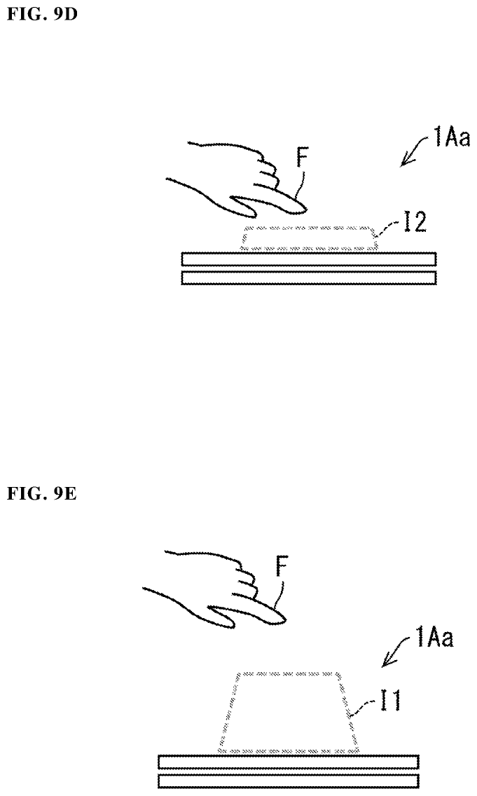

FIG. 9A through FIG. 9E are for describing the operations of the input device 1Aa. The image control unit 32 in the input device 1Aa controls the light source 12A in the stereoscopic image display unit 10A so that the light source is turned on while the input device 1Aa is waiting for an input from the user. Thus, as illustrated in FIG. 9A, the stereoscopic image display unit 10A forms the stereoscopic image I1. Assume that at this point the switch is in the “off” state.

The user then positions a finger F at the location where the stereoscopic image I1 is formed. Once the input detection unit 31 detects the input from the user, the input device 1Aa changes the switch to the on state. At this point the image control unit 32 turns off the light source 12A and turns on the light source 12B. Thus, the stereoscopic images I2 is formed instead of the stereoscopic image I1.

The user then moves the finger F away from the switch. At this point the switch remains on and the stereoscopic image I2 remains as it was formed as illustrated in FIG. 9C.

Next, the user positions a finger F at the location where the stereoscopic image I2 is formed as illustrated in FIG. 9D.

Once the input detection unit 31 detects the input from the user, the input device 1Aa changes the switch to the “off” state. At this point, the image control unit 32 turns off the light source 12B and turns on the light source 12A. Thus, the stereoscopic images I1 is formed instead of the stereoscopic image I2 as illustrated in FIG. 9E.

The input device 1A of this embodiment is configured such that the stereoscopic image I is a truncated trapezoid shape whose height coincides with the longitudinal direction (which is perpendicular to the light guide plate 11). Further, the user moves a finger F toward the emission surface 11a in a direction perpendicular to the emission surface 11a of the light guide plate 11. However, an input device of the present invention is not limited hereto. An input device in one aspect of the present invention may be configured so that the stereoscopic image I is a truncated trapezoid shape whose height coincides with the vertical direction (which is parallel to the light guide plate 11), and the user moves a finger F vertically with respect to the emission surface 11a of the light guide plate 11. The input device may also be configured so that stereoscopic image may also be a truncated trapezoid shape whose height is at an angle relative to the vertical direction, and the user moves the finger F at an angle relative to the emission surface 11a of the light guide plate 11.

An input device of one aspect of the present invention may also be modified so that the detection position of the position detection sensor 2 changes to a location away from the emission surface 11a of the light guide plate 11 when the input detection unit 31 has detected an input from the user. Here, when the user's finger F is detected in the space, the position of the finger F is unsteady and can lead to chattering where the switch cycles on and off repeatedly for brief periods. The above configuration changes the detection position of the position detection sensor 2 to a location away from the emission surface 11a of the light guide plate 11 when the input detection unit 31 has detected the input from the user. A state can be maintained where the position detection sensor 2 is detecting the finger F, even if the position of the finger F is unsteady after the input detection unit 31 has detected the input from the user. Consequently, it is possible to prevent chattering.

The aforementioned configuration is particularly effective when the input device functions as a momentary switch. That is, when the input device is acting as a momentary switch, the user needs to continue to keep a finger F in the space for the period the user wishes to keep the switch on. It is possible that at this point the position of the finger F may become unsteady; however, the above configuration is capable of suppressing chatter.

An input device of one aspect of the present invention may also be configured with a plurality of stereoscopic image display units 10 and a plurality of position detection sensors 2 corresponding to the plurality of stereoscopic image display units 10. The above configuration makes it possible to implement an input device responsive to a plurality of types of inputs from a user. This kind of input device may be suited for adoption in an operation panel for factory automation (FA), for a home appliance, or the like.

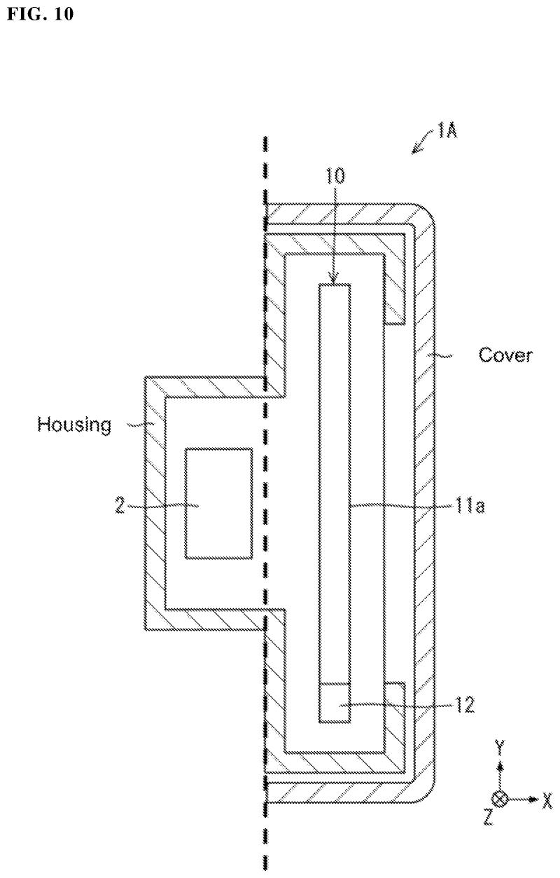

Note that while in this embodiment the stereoscopic image display unit 10 and position detection sensor 2 are stored inside a housing, an input device of the present invention is not limited hereto. An input device of one aspect of the present invention may be structured so that the stereoscopic image display unit 10 and the position detection sensor 2 are not stored in the same housing, but are separate from each other. FIG. 10 is a diagram illustrating one example of the input device 1A of the first embodiment. The stereoscopic image display unit 10 and the position detection sensor 2 may be separated, for example, at the cross-section indicated by the dotted line in FIG. 10.

Here, if the input device 1A is used as a lighting switch in a building, for instance, the position detection sensor 2 may be embedded in the wall. However, the standards pertaining to the size of the sensor that can be embedded in a wall can vary depending on the country. If the structure of the input device is such that the stereoscopic image display unit 10 and the position detection sensor 2 are separate from each other, the position detection sensor 2 can be made a size that meets the aforementioned standards and embedded in the wall, and the stereoscopic image display unit 10 can be installed thereafter. The stereoscopic image display unit 10 may thus be installed to coincide with the detection position of the sensor. It is also easy to change the design of the stereoscopic image display unit 10.

### 4. Modification Examples

While an embodiment of the present invention is described above in detail, all points in the previous description are merely examples of the present invention. It goes without saying that various modifications and variations are possible without departing from the scope of the invention. For instance, the following modifications are possible. Note that constituent elements that are identical to the constituent elements in the above described embodiment are given the same reference numerals and where appropriate, a description of features that are identical to the above embodiment is omitted. The following modifications may be combined as appropriate.

4.1

A light guide plate 11A next described is modification example of the light guide plate 11.

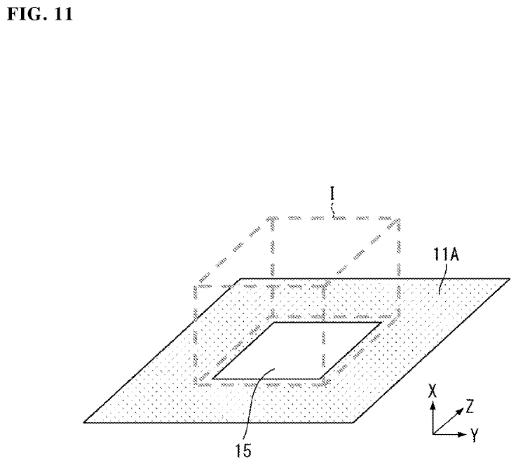

FIG. 11 is a perspective view illustrating a configuration of the light guide plate 11. As illustrated in FIG. 11, an opening 15 is formed in the light guide plate 11A.

The opening 15 is for transmitting light that the position detection sensor 2 uses to detect an object. The opening 15 is formed in the input device 1A in this modification example so that when the input device 1A is viewed from the front (a direction perpendicular to the emission surface 11a), the outline of the stereoscopic image I and the outer circumference of the opening 15 are identical or substantially identical.

The above configuration allows the user to use the opening 15 as a reference surface when recognizing the stereoscopic image I. The three dimensionality of the stereoscopic image I thus improves. This also improves the design characteristics of the input device 1A.

4.2

An input device 1B is described next as another modification example of the input device 1A.

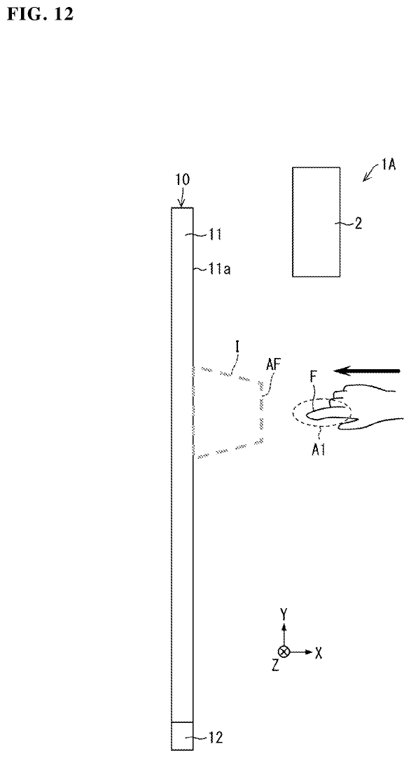

FIG. 12 is a side view illustrating a configuration of an input device 1B. As illustrated in FIG. 12, the location at which the position detection sensor 2 is placed in the input device 1B differs from the location in the input device 1A of the first embodiment. More specifically, the position detection sensor 2 in the input device 1B is placed more in front (toward the positive X axis) than the stereoscopic image display unit 10, and outward of the light guide plate 11 when the input device 1A is viewed from the front (from a direction perpendicular to the emission surface 11a). The position detection sensor 2 is also configured to detect an object that is in a range A1 in front of the stereoscopic image I by predetermined distance therefrom in a direction perpendicular to the emission surface 11a of the light guide plate 11.

Similar to the input device 1A in first embodiment, the above configuration allows the user to be more quickly notified that the input device 1A has accepted the input from the user. Thus, the user can be given a more satisfactory operational feel with respect to the input device 1A.

The position detection sensor 2 is also placed outward of the light guide plate 11 when the input device 1A is viewed from the front (from a direction perpendicular to the emission surface 11a). Thus, even if the light guide plate 11 is transparent it is possible to ensure that the user does not see the position detection sensor 2 when the user is looking at the stereoscopic image I.

4.3

An input device 1C is described next as another modification example of the input device 1A.

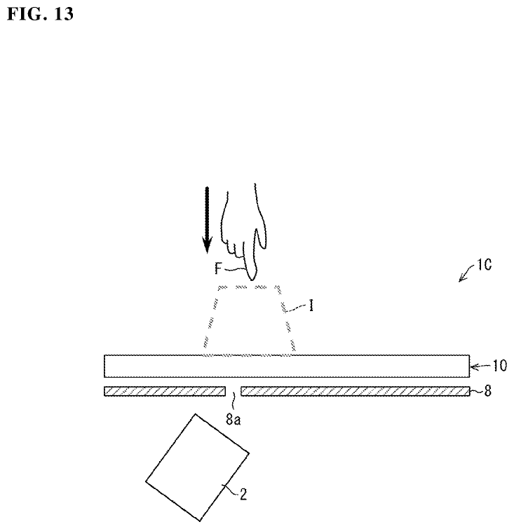

FIG. 13 is a diagram illustrating the structure of the input device 1C. As illustrated in FIG. 13, in addition to the configuration of the input device 1A of the first embodiment, the input device 1C is also provided with a sheet 8.

The sheet 8 is placed between the light guide plate 11 and the position detection sensor 2. The sheet 8 is printed with a design, e.g., wood grain or the like, on the front surface. Additionally, the light guide plate 11 is transparent as described above. The above configuration makes it possible to show a user the design printed on the front surface of the sheet when the user performs an input action with respect to the input device 1A. Thus, the flexibility of designing the input device 1C improves.

The sheet 8 may also have a slit 8a formed therein to allow light emitted from the position detection sensor 2 to pass therethrough. The slit 8a may be formed at an end part of the sheet 8 so that the user cannot identify the slit.

Note that the sheet 8 may be paper with the above design printed thereon, or may be a panel with the above design printed thereon. No slit 8a is required as long as the sheet 8 is able to transmit the light emitted from the position detection sensor 2.

4.4

An input device 1D is described next as another modification example of the input device 1A.

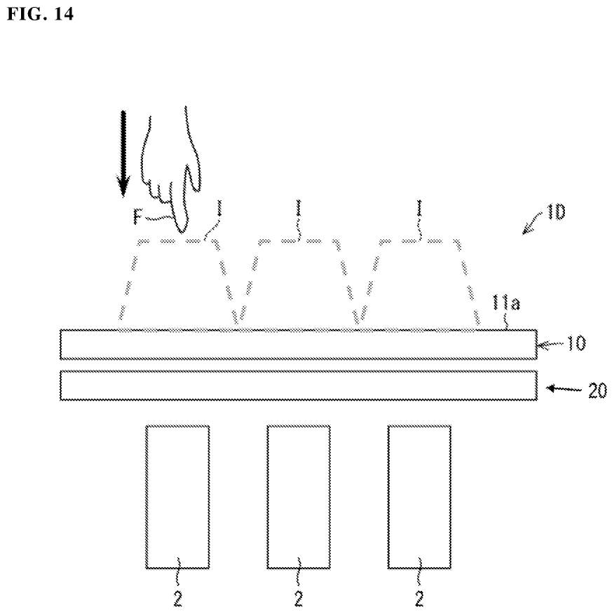

FIG. 14 is a diagram illustrating the configuration of the input device 1D. As illustrated in FIG. 14, in addition to the configuration of the input device 1A of the first embodiment, the input device 1D is provided with a 2D-image display unit 20.

The 2D-image display unit 20 is placed between the light guide plate 11 and the position detection sensor 2. The 2D-image display unit 20 is a display device such as a liquid crystal display (LCD) or an organic light emitting diode (OLED).

The stereoscopic image display unit 10 of the input device 1D is configured to present a plurality of stereoscopic images I. The aforementioned configuration may be implemented by including a plurality of light sources 12 in the input device 1D corresponding to the plurality of stereoscopic images I, and forming optical-path changing portions in the light guide plate 11 to correspond to each of the light sources 12.

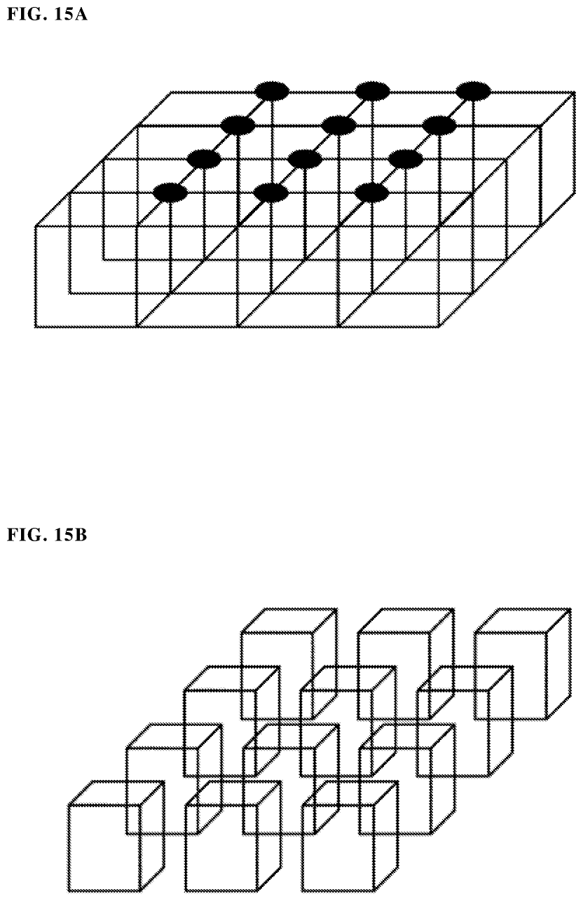

FIG. 15A and FIG. 15B are diagrams illustrating examples of a stereoscopic image I formed by a stereoscopic image display unit 10 in this modification example. The stereoscopic image display unit 10 in the modification example may form a stereoscopic image of a grid as illustrated in FIG. 15A, or may form a stereoscopic image of a plurality of button shapes as illustrated in FIG. 15B.

In the input device 1D of this modification example, the 2D-image display unit 20 presents images corresponding to each of the stereoscopic images. The 2D-image display unit 20 may present, for instance, characters at positions corresponding to the stereoscopic images where the character is an object for an input action with respect to the stereoscopic image (e.g., when the input device is used as an elevator input unit, the characters may be the numbers indicating a destination floor). Thus, the user can recognize what action is needed when the user attempts to provide input.

Moreover, the 2D-image display unit 20 may be configured so that the image to be presented is changeable. Thus, an input menu, which an object for an input action from the user, may change as appropriate.

4.5

A switch combining an input device of the present invention and a typical push-type switch (pushbutton switch) is described next.

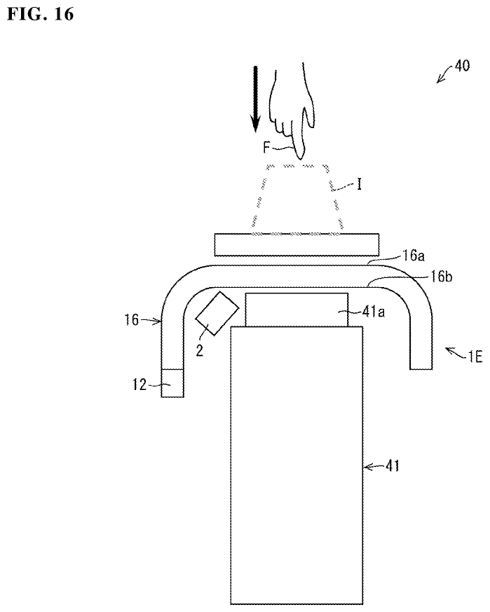

FIG. 16 is a cross-sectional view illustrating a structure of a switch 40 according to the modification example; as illustrated in FIG. 16, the switch 40 is provided with an input device 1E, a push switch 41, and a cover 42. A typical switch may be adopted as the push switch 41; therefore, a simplified view of the push switch 41 is depicted in FIG. 16.

The push switch 41 is provided with a pressure-receiving component 41a. The push switch 41 is configured to change the switch between on and off via a downward push (FIG. 16) on the pressure-receiving component 41a.

The input device 1E is provided with a light guide plate 16 instead of the light guide plate 11 of the input device 1A of first embodiment. The light guide plate 16 is U-shaped in a cross section that is perpendicular to the vertical direction in FIG. 16. The light source 12 in the input device 1E is placed at an end part of the light guide plate 16. Light emitted from the light source 12 is reflected inside the light guide plate 16 while being guided therethrough. The optical path of the light guided through the light guide plate 16 then changes due to optical-path changing portions (not shown) formed on the opposing surface 16b which faces the emission surface 16a of the light guide plate 16, exits from the emission surface 16a, and forms the stereoscopic image I.

The cover 42 is transparent and is for preventing the user's finger from contacting the light guide plate 16.

The switch 40 is capable of detecting an operation from the user via the following two methods. One method is to detect the user's finger F when the finger F is positioned at a location that is a predetermined distance away from the emission surface 16a of the light guide plate 16, as described in the first embodiment.

Another method is to detect the user physically pushing the pressure-receiving component 41a in the push switch 41. In this case, the cover 42 moves downward due to the user pushing downward on the cover 42. Next, the light guide plate 16 moves downward due to the cover 42 pushing downward on the light guide plate 16. Then, the user's operation is detected due to the pressure-receiving component 41a of the push switch 41 moving downward due to the light guide plate 16.

As above described, the switch 40 functions as a pushbutton switch and as a contactless switch.

4.6

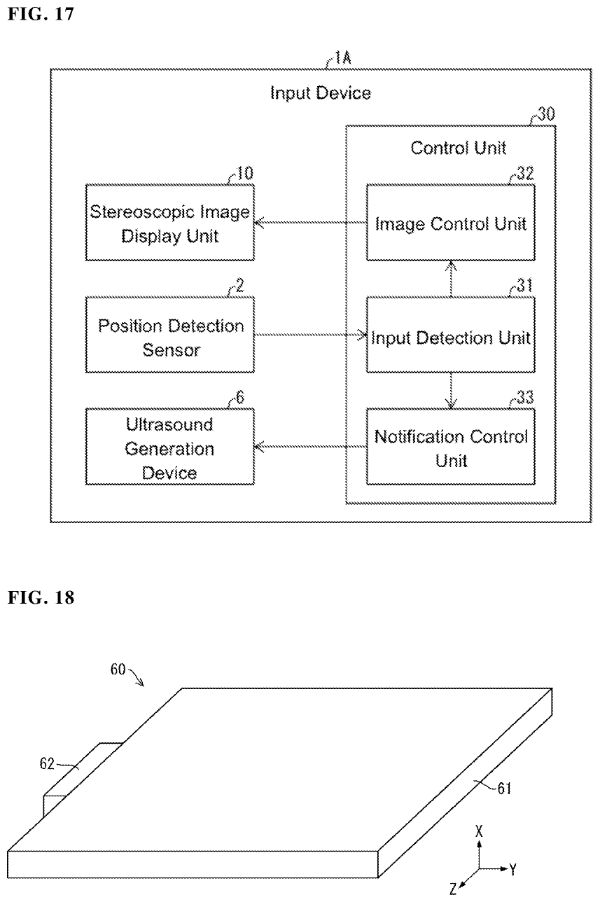

An input device 1F is described next as another modification example of the input device 1A. FIG. 17 is a block diagram of the input device 1F in the modification example.

As illustrated in FIG. 17, the input device 1F is provided with an ultrasound generation device 6 (tactile stimulus device) instead of the sound output unit 3 of the first embodiment.

The ultrasound generation device 6 receives an instruction from the notification control unit 33 and outputs ultrasonic waves. The ultrasound generation device 6 is provided with an ultrasonic transducer array (not shown) where multiple ultrasonic transducers are arranged in a grid. The ultrasound generation device 6 generates an ultrasonic wave from the ultrasonic transducer array to create a focal point of ultrasonic waves at a desired location in the air. A static pressure (also referred to as acoustic radiation pressure) is created at the focal point of the ultrasonic waves. If a human body part (e.g., the user's finger) is at the focal point of the ultrasonic waves, a pressure is applied to the physical object due to the static pressure. Thus, the ultrasound generation device 6 is capable of remotely providing a stimulus to the tactile sense of the user's finger.

On acquiring information from the position detection sensor 2 to the effect that the user's finger was detected, the notification control unit 33 in the input device 1F outputs an instruction to the ultrasound generation device 6 to generate ultrasonic waves. Thus, the input device 1F is able to provide notification to the user that the input of the user was accepted.

4.7

The stereoscopic image display unit 10 in the input device 1A may be replaced with the stereoscopic image display unit 60 described below.

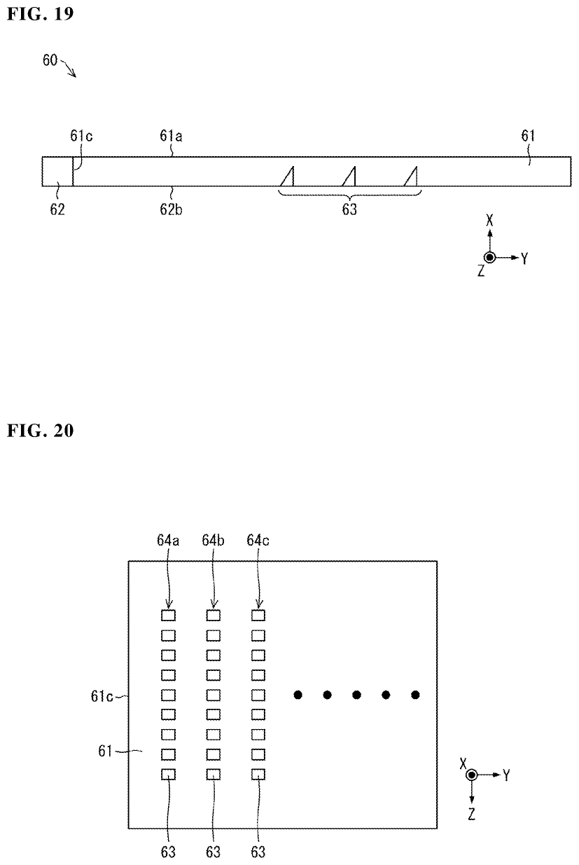

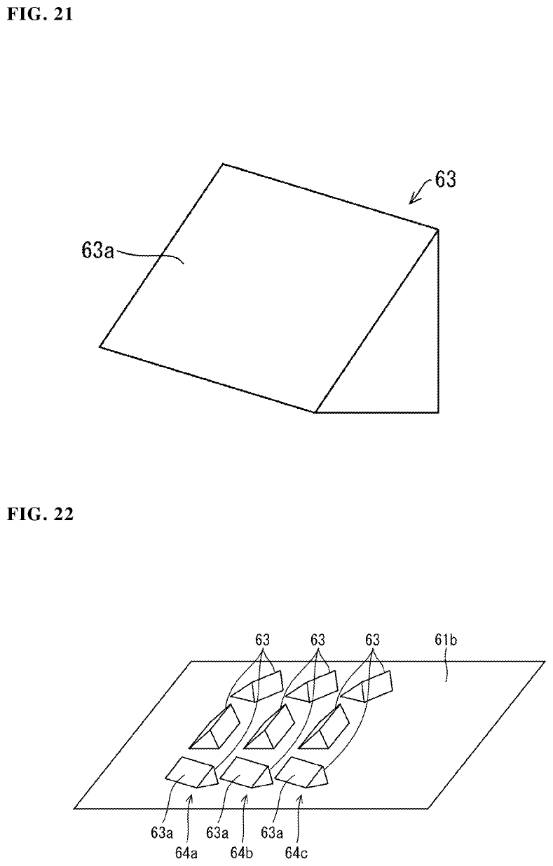

FIG. 18 is a perspective view of the stereoscopic image display unit 60; FIG. 19 is a cross-sectional view illustrating a configuration of the stereoscopic image display unit 60; FIG. 20 is a plan view illustrating a configuration of the stereoscopic image display unit 60; and FIG. 21 is a perspective view illustrating a configuration of optical-path changing portions 63 provided in the stereoscopic image display unit 60.

As illustrated in FIG. 18 and FIG. 19, the stereoscopic image display unit 60 is provided with the light guide plate 61 and a light source 62.

The light guide plate 61 guides light entering from the light source 62 (i.e., incident light). The light guide plate 61 is produced from a resin material which is transparent and has a relatively high refractive index. The light guide plate 61 may be produced from, for instance, a polycarbonate resin, a poly methyl methacrylate resin, or the like. In this modification example, the light guide plate 61 is produced from a poly methyl methacrylate resin. The light guide plate 61 is provided with an emission surface 61a (light emitting surface), a rear surface 61b, and an incidence surface 61c as illustrated in FIG. 19.

The emission surface 61a emits light that is guided by the light guide plate 16 and modified by an optical-path changing portion 63. The emission surface 61a is configured as the front surface of the light guide plate 61. The rear surface 61b and the emission surface 61a are mutually parallel, and the later-described optical-path changing portion 63 is arranged thereon. Light emitted from the light source 62 is incident on the light guide plate 61 at the incidence surface 61c.

Light emitted from the light source 62 and entering the light guide plate 61 from the incidence surface 61c is totally reflected between the emission surface 61a and the rear surface 61b and guided through the light guide plate 61.

As illustrated in FIG. 19, an optical-path changing portion 63 is formed on the rear surface 61b inside the light guide plate 61; the optical-path changing portion 63 changes the optical path of light guided through the light guide plate 61 and causes the light to exit from the emission surface 61a. A plurality of optical-path changing portions 63 is provided on the rear surface 61b of the light guide plate 61.

As illustrated in FIG. 20, the optical-path changing portions 63 are provided along a direction parallel to the end incidence surface 61c. As illustrated in FIG. 21, the optical-path changing portions 63 are tetrahedrons provided with reflection surfaces 63a that reflect (totally reflect) incident light. For example, the optical-path changing portions 63 may be recesses formed in the rear surface 61b of the light guide plate 61. Note that the optical-path changing portions 63 are not limited to being tetrahedrons. As illustrated in FIG. 20, the plurality of optical-path changing portions 63 may be made up of a plurality of groups of optical-path changing portions 64a, 64b, 64c . . . formed on the rear surface 61b of the light guide plate 61.

FIG. 22 is a perspective view illustrating a distribution of the optical-path changing portions 63. As illustrated in FIG. 22, the plurality of optical-path changing portions 63 in each group of optical-path changing portions 64a, 64b, 64c . . . are arranged on the rear surface 61b of the light guide plate 61 so that the angles of the reflection surfaces 63a are mutually different in relation to the direction from which light is incident. Thus, each group of optical-path changing portions 64a, 64b, 64c . . . changes the optical path of the incident light and causes the light to exit in various directions from the emission surface 61a.

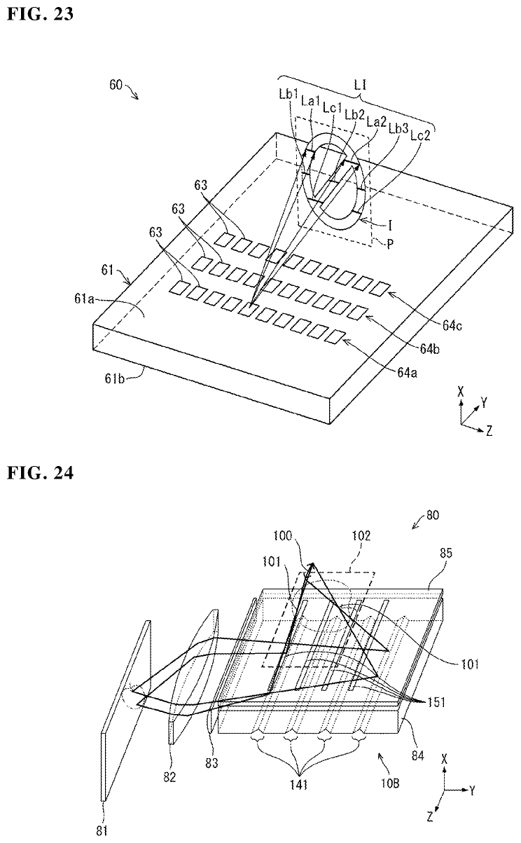

The method of how the stereoscopic image display unit 60 forms a stereoscopic image I is described next with reference to FIG. 23. In this case the plane perpendicular to the emission surface 61a of the light guide plate 61 is the stereoscopic image forming plane P, and light modified by the optical-path changing portions 63 form a stereoscopic image I as a planar image in the stereoscopic image forming plane P.

FIG. 23 is a perspective view illustrating how a stereoscopic image I is formed by the stereoscopic image display unit 60; note that in the case described, the stereoscopic image I formed in the stereoscopic image forming plane P is a ring with an oblique line therethrough.

As illustrated in FIG. 23, the optical-path changing portions 63 from a group of optical-path changing portions 64a may change the optical path of light in the stereoscopic image display unit 60 so that the modified light intersects with the lines La1 and La2 in the stereoscopic image forming plane P. Hereby a line image LI, which is a portion of the stereoscopic image I is formed in the stereoscopic image forming plane P. The line image LI is parallel to the YZ plane. Thus, light from multiple optical-path changing portions 63 belonging to the group of optical-path changing portions 64a create a line image LI from the line La1 and the line La2. Light creating an image of the line La1 and the line La2 only need at least two optical-path changing portions 63 in the group of optical-path changing portions 64a.

Similarly, light whose optical path changes due to the optical-path changing portions 63 in a group of optical-path changing portions 64b intersect with the lines Lb1, Lb2, and Lb3 in the stereoscopic image forming plane P. Hereby a line image LI, which is a portion of the stereoscopic image I is formed in the stereoscopic image forming plane P.

Light whose optical path changes due to the optical-path changing portions 63 in a group of optical-path changing portions 64c intersects with the lines Lc1 and Lc2. Hereby a line image LI, which is a portion of the stereoscopic image I is formed in the stereoscopic image forming plane P.

The groups of optical-path changing portions 64a, 64b, 64c . . . form line images LI at mutually different positions along the X axis direction. Reducing the distance between the groups of optical-path changing portions 64a, 64b, 64c . . . in the stereoscopic image display unit 60 reduces the distance between the line images LI produced by the groups of optical-path changing portions 64a, 64b, 64c . . . along X axis direction. As a result, the optical-path changing portions 63 in the groups of optical-path changing portions 64a, 64b, 64c . . . in the stereoscopic image display unit 60 change the optical path of light whereby grouping the plurality of line images LI created by this light forms a stereoscopic image I as a planar image in the stereoscopic image forming plane P.

Note that the stereoscopic image forming plane P may be perpendicular to the X axis, perpendicular to the Y axis, or perpendicular to the Z axis. Additionally, the stereoscopic image forming plane P may be non-vertical relative to the X axis, the Y axis, or the Z axis. Moreover, the stereoscopic image forming plane P may be curved instead of a flat plane. In other words, the stereoscopic image display unit 60 may form a stereoscopic image I in any desired plane in a space (flat or curved) by way of the optical-path changing portions 63. A three-dimensional image may thus be formed by a combination of a plurality of planar images.

4.8

The stereoscopic image display unit 10 in the input device 1A may be replace replaced with the stereoscopic image display unit 80 described below.

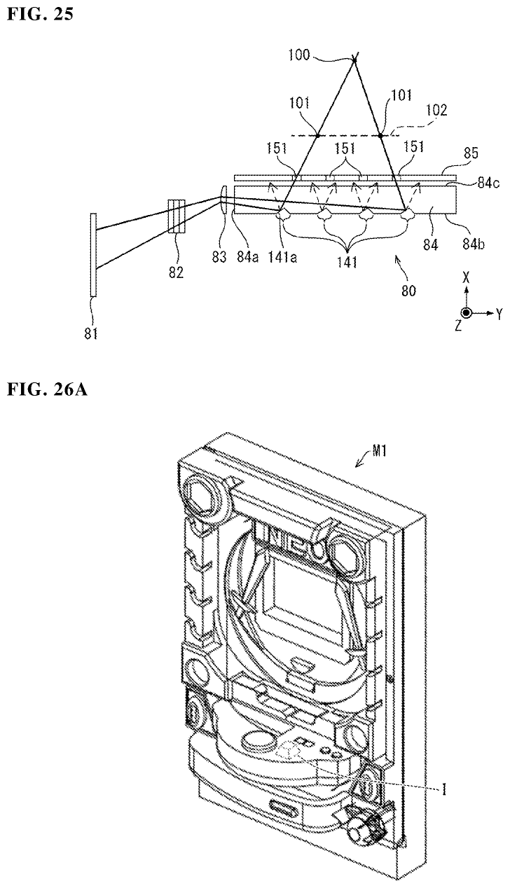

FIG. 24 is a perspective view of the stereoscopic image display unit 80. FIG. 25 is a cross-sectional view illustrating a configuration of the stereoscopic image display unit 80; and

The stereoscopic image display unit 80 is provided with an image display device 81, an image forming lens 82, a collimating lens 83, a light guide plate 84, and a mask 85 as illustrated in FIG. 24 and FIG. 25. The image display device 81, the image forming lens 82, the collimating lens 83, and the light guide plate 84 are arranged in this order along the Y axis direction. In addition, the light guide plate 84 and the mask 85 are arranged in this order along the X axis direction.

The image display device 81 presents a two-dimensional image that is projected in a space via the stereoscopic image display unit 80 in a display area in accordance with an image signal received from a control device (not shown). The image display device 81 is, for instance, a typical liquid crystal display that is capable of outputting image light by displaying an image in a display region. In the example depicted, the display region of the image display device 81 and the incidence surface 84a which faces said display region in the light guide plate 84 are both arranged parallel to the XZ plane. The rear surface 84b and the emission surface 84c (i.e., a light emitting surface) in the light guide plate 84 are arranged parallel to the YZ plane. The emission surface 84b which emits light onto the mask 85 faces the rear surface 84c whereon prisms 141 (later described) are provided. Additionally, the surface whereon slits 151 (later described) are provided in the mask 85 is parallel to the YZ plane. Note that the display region in the image display device 81 and the incidence surface 84a in the light guide plate 84 may face each other, or the display region in the image display device 81 may be inclined relative to the incidence surface 84a.

The image forming lens 82 is disposed between the image display device 81 and the incidence surface 84a. Image light exits the image display device 81 and enters the image forming lens 82 which focuses the image light in the YZ plane; the image light exits the image forming lens 82 and enters the collimating lens 83. Note that the YZ plane is parallel to the length of the incidence surface 84a. The image forming lens 82 may be of any type so long as it is capable of focusing the image light. The image forming lens 82 may be a bulk lens, a Fresnel lens, a diffraction lens, or the like. The image forming lens 82 may also be a combination of a plurality of lenses arranged along the Z axis direction.

The collimating lens 83 is disposed between the image display device 81 and the incidence surface 84a. The collimating lens 83 collimates the image light focused by the image forming lens 82 onto the XY plane; the XY plane is orthogonal to the length of the incidence surface 84a. Collimated image light exiting the collimating lens 83 enters the incidence surface 84a of the light guide plate 84. Similar to the image forming lens 82, the collimating lens 83 may be a bulk lens, or a Fresnel lens. The image forming lens 82 and the collimating lens 83 may be arranged in the opposite order. Additionally, the functions of the image forming lens 82 and the collimating lens 83 may be achieved through a single lens or through a combination of multiple lenses. In other words, the combination of the image forming lens 83 and the collimating lens 81 may be configured in any manner so long as the image light output from the display region of the image display device 82 converges in the YZ plane, and collimated in the XY plane.

The light guide plate 84 is a transparent resin; image light collimated by the collimating lens 83 enters the light guide plate 84 at the incidence surface 84a and exits the light guide plate 84 from the emission surface 84. In the example depicted, the light guide plate 84 is a flat rectangular panel with the surface facing the collimating lens 83 and parallel to the XZ plane taken as the incidence surface 84a. The rear surface is taken as the surface parallel to the YZ plane and located in the negative X axis direction while the emission surface 84c is taken as the surface parallel to the YZ plane and facing the rear surface 84b. A plurality of prisms 141 (i.e., emitting structures, optical-path changing portions) are provided in light guide plate 84.

The plurality of prisms 141 reflect the image light entering the light guide plate from the incident surface 84a. The prisms 141 are provided on the rear surface 84b of the light guide plate 84 protruding therefrom toward the emission surface 84c. For example, if image light propagates along the Y axis direction, the plurality of prisms 141 may be substantially triangular grooves with a predetermined width in the Y axis direction (e.g., 10 μm) and arranged at a predetermined interval along the Y axis direction (e.g., 1 mm). The prisms 141 include a reflective surface 141a, which is the optical surface closer to the incidence surface 84a relative to the direction along which the image light travels (i.e., the positive Y axis direction). In the example depicted, the plurality of prisms 141 are provided parallel to the Z axis on the rear surface 84b. Thus, the reflection surfaces 141a in the plurality of prisms 141 are provided parallel to the Z axis and orthogonal to the Y axis; the reflection surfaces 141a reflect the image light entering from the incidence surface 84a and propagating along the Y axis direction. Each of the plurality of prisms 141 causes image light emitted from mutually different positions in the display region of the image display device 81 along the direction orthogonal to the length of the incidence surface 84a (i.e., the X axis) to exit from the emission surface 84c. That is, the prisms 141 allow image light to exit from one surface of the light guide plate 84 toward a predetermined viewpoint 100. Details of reflection surfaces 141a are described later.

The mask 85 is configured from a material that is opaque to visible light and includes a plurality of slits 151. The mask 85 only allows light emitted from the emission surface 84c of the light guide plate 84 and oriented toward the image forming point 101 in a plane 102 to pass therethrough via the plurality of slits 151.

The plurality of slits 151 only allows light emitted from the emission surface 84c of the light guide plate 84 that is oriented towards the image forming point 101 in a plane 102 to pass therethrough. In the example depicted, the plurality of slits 151 are provided parallel to the Z axis. Individual slits 151 may also correspond to any prism 141 in the plurality of prisms 141.

When configured as above described, a stereoscopic image display unit 80 forms and projects the image presented by the image display device 81 onto a virtual plane 102 outside the stereoscopic image display unit 80. More specifically, image light emitted from the display region in the image display device 81 passes through the image forming lens 82 and the collimating lens 83, whereafter the image light enters the incidence surface 84a which is one end surface of the light guide plate 84. Subsequently, the image light incident on the light guide plate 84 propagates therethrough and arrives at the prisms 141 provided on the rear surface 84b of the light guide plate 84. The reflection surfaces 141a reflect the image light arriving at the prisms 141 toward the positive X axis direction and thereby causes the image light to exit the light guide plate 84 from the emission surface 84c which is parallel to the YZ plane. The image light emitted from the emission surface 84c and passing through the slits 151 of the mask 85 form an image of the image forming point 101 in the plane 102. In other words, image light emanating from points in the display region of the image display device 81 converge in the YZ plane, collimate in the XY plane and thereafter is projected onto an image forming point 101 in a plane 102. The stereoscopic image display unit 80 processes all the points in the display region in the aforementioned manner to thereby project an image output in the display region of the image display device 81 onto the plane 102. Thus, when a user views this virtual plane 102 from a viewpoint 100, the user perceives the image that is projected in air. Note that the plane 102 whereon the projected image is formed is a virtual plane; however, a screen may be disposed in the plane 102 to improve visibility.

Note that the stereoscopic image display unit 80 in this embodiment is configured to form an image via the image light emitted from the emission surface 84c and passing through the slits 151 provided in a mask 85. However, the configuration may exclude the mask 151 and the slits 85 if it is possible to form an image from the image light at an image forming point 101 in the virtual plane 102.

For example, the angle between the reflection surfaces on the prisms 141 and the rear surface 84b may be established to increase with distance from the incident surface 84a to form an image with image light at an image forming point 101 in the virtual plane 102. Note that the angle of the prism 141 that is furthest from the incidence surface 84a is preferably an angle that causes total reflection of light from the image display device 81.

Light emanates from a point on the display region of the image display device 81 oriented toward a predetermined viewpoint; with the angles configured as above described, the closer this emanation point is to the rear surface 84b (i.e., more toward the negative X axis direction) the further away the prism 141 from the incidence surface 84a that reflects this light. However, without being limited to this configuration, it is sufficient to map a location in the X axis direction on the display region of the image display device 81 to a prism 141. In addition, light reflected from a prism 141 is increasingly oriented toward the incidence surface 84a with distance of the prism 141 from the incidence surface 84a; whereas, light reflected from a prism 141 is increasingly oriented away from the incidence surface 84a as the prism 141 approaches the incidence surface 84a. Therefore, light from the image display device 81 can be emitted toward a specific viewpoint even without the mask 85. Light exiting from the light guide plate 84 forms an image in the plane on which the image is projected and diffuses in accordance with distance from the plane in the Z axis direction. As a result, a parallax effect may be created in the Z axis direction whereby an observer may align both eyes along the Z axis direction to stereoscopically view an image projected in the Z axis direction.

Given that none of the light reflected by the prisms 141 and oriented towards the viewpoint is blocked in the above mentioned configuration, an observer may see an image presented on the image display device 81 and projected in the air even if the observer's viewpoint moves along the Y axis direction. However, the angle between light rays from the prisms 141 oriented toward the viewpoint and the reflection surface of the prisms 141 changes with the location of the viewpoint along the Y axis direction; therefore, the position of the viewpoint in the image display device 81 corresponding to the light ray also changes with the location of the viewpoint along the Y axis direction. Additionally, in this example light from each of the points in the image display device 81 is also formed in the Y axis direction to some extent due to the prisms 141. Therefore, an observer with both eyes aligned along the Y axis direction may also view a stereoscopic type image.

Moreover, the above mention configuration excludes the mask 85; therefore, this reduces the loss of light intensity and allows for the stereoscopic image display unit to project a brighter image into a space. Additionally, since no mask is used, the stereoscopic image display unit allows an object behind the light guide plate 84 (not shown) and the projected image to both be perceived by an observer.

4.9

The stereoscopic image display unit 10 in the input device 1A may be configured to form images individually for a plurality of viewpoints. The stereoscopic image display unit may include, for instance, a right-eye display pattern for creating a right-eye image, and a left-eye display pattern for creating a left-eye image. In this case, the stereoscopic image display unit 10 can form an image that has three dimensionality. The stereoscopic image display unit 1 may be configured to form images individually for three or more viewpoints.

The stereoscopic image display unit 10 may also use the light emitted from a physical object to emit light from the optical elements and form a stereoscopic image or a reference image, with the physical object acting as an image source for the stereoscopic image or reference image. For example, consider (1) a display device that uses a two-plane reflector array structure where a plurality of mutually orthogonal mirror plane elements is arranged in an optical coupling element plane, and (2) a display device that uses a half-mirror, that is, what is known as a paper ghost display device. Either of these may serve as a display device that uses the light emitted from a physical object to emit the light from the optical elements and form a stereoscopic image or a reference image with the physical object acting as the source image.

4.10

An example of adopting the input device 1A in a game machine M is described next.

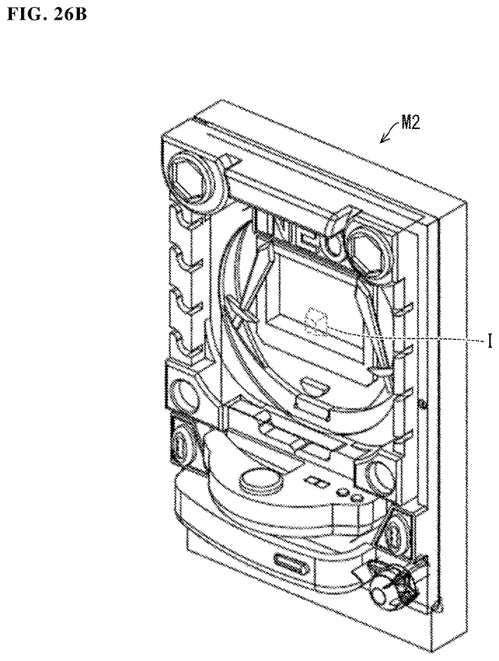

FIG. 26A and FIG. 26B are perspective views illustrating examples of a game machine wherein the above input device 1A is adopted. Note that the input device 1A is not depicted in FIG. 26A and FIG. 26B.

As illustrated in FIG. 26A, a game machine M1 includes a game board via which the user manipulates the game machine M1, and the input device 1A forms a stereoscopic image I as at least one of a plurality of switches a user manipulates on the game board.

As illustrated in FIG. 26B, the input device 1A in a game machine M2 may also form an image that overlaps a screen whereon an effect is presented to a user, and form a stereoscopic image I as a switch that is an object for input from the user. In this case, the input device 1A may present the stereoscopic image I only when the stereoscopic image I is needed for presentation of an effect.

Overview

An input device according to an aspect of the present invention includes a light guide plate configured to direct light entering from a light source so that the light exits from a light emitting surface and forms an image in a space, the image an object for an input action from a user; a sensor configured to detect an object employed by a user for the input action; an input detection unit configured to detect an input from a user on the basis of a detection result from the sensor for the object; and a notification unit configured to notify a user that the input was detected when the input detection unit has detected an input from a user; and the sensor is placed in a space opposite the light emitting surface of the light guide plate.

The above configuration allows for simplifying the structure in the space from the light guide plate toward the user because the sensor is placed opposite the light emitting surface of the light guide plate.

An input device according to one aspect of the present invention may be configured preferably so that the light guide plate is transparent.

The above configuration facilitates transmission of the detection light emitted from the sensor for detecting an object through the light guide plate.

An input device according to one aspect of the present invention may be configured preferably to further include a plurality of optical-path changing portions formed on the opposing surface that opposes the light emitting surface in the light guide plate, the optical-path changing portions having reflection surfaces for reflecting light guided through said light guide plate toward the light emitting surface; and the surface density of the reflection surfaces to the opposing surface is less than or equal to 30%.

The above configuration minimizes dampening of the detection light due to the light guide plate even when the sensor is placed in the space at the opposing surface.

An input device according to one aspect of the present invention may be configured preferably to further include a plurality of the light guide plates; the plurality of light guide plates each forming a different one of the image in the space; and the notification unit changing the images when the input is detected.

An input device according to one aspect of the present invention may be configured preferably so that the light guide plate forms an image at or near the location at which the sensor detects the object.

An input device according to an aspect of the present invention includes a light guide plate configured to direct light entering from a light source so that the light exits from a light emitting surface and forms an image in a space, the image an object for an input action from a user; a sensor configured to detect an object employed by a user for the input action; an input detection unit configured to detect an input from a user on the basis of a detection result from the sensor for the object; and a notification unit configured to notify a user that the input was detected when the input detection unit has detected an input from a user; the light guide plate forming the image at or near the location at which the sensor detects the object.

The operational feel of existing input devices tends to be difficult for a user to discern. Whereas, the above configuration provides a notification that the input device detected the object when the user positions an object for performing an input action at or near the position at which the image is formed. Thus, this allows the user to be given an operational feel with respect to the input device.

An input device according to one aspect of the present invention may be configured preferably so that the input detection unit detects the input when the sensor has detected that the object is positioned along the direction the input action is performed in a region a predetermined distance away from where the image is formed in a direction opposite the direction the input action is performed.

The above configuration allows detection of an input from the user prior to the object arriving at the location at which the image is formed. Therefore, the user can be more quickly notified that the input device accepted the input from the user. Thus, the user can be given a more satisfactory operational feel with respect to the input device.

An input device according to one aspect of the present invention may be configured preferably so that the notification unit causes the display state of the image to vary when the input detection unit has detected an input from a user.

The above configuration allows for varying the image to notify the user that the input was accepted.

An input device according to one aspect of the present invention may be configured preferably to further include a sound output device serving as a notification unit for outputting a sound when the input detection unit has detected an input from a user.

The above configuration allows for notifying using sound to notify the user that the input device accepted an operation with respect to the input device.

An input device according to one aspect of the present invention may be configured preferably to further include a tactile stimulus device serving as a notification unit for remotely stimulating the sense of touch of a human body serving as the object.

The above configuration, the above configuration allows for using stimulation of the sense of touch to notify the user that the input device accepted an operation with respect to the input device.

An input device according to one aspect of the present invention may be configured preferably so that an opening is formed in the light guide plate for transmitting light for the sensor to detect the object; and when the image is viewed from a direction perpendicular to the light emitting surface, the outline of the image and the outer circumference of the opening have the same or substantially the same shape.

The above configuration allows the user to use the opening as a reference surface when recognizing the image. The three dimensionality of the image thus improves. This also improves the design characteristics of the input device.

An input device according to one aspect of the present invention may be configured preferably to include a sheet formed opposite the light emitting surface of the light guide plate, the sheet having a design thereon corresponding to the image.

The above configuration makes it possible to show a user the design formed on the front surface of the sheet when the user performs an input action with respect to the input device. Thus, the flexibility of designing the input device improves.

An input device according to one aspect of the present invention may be configured preferably to include a 2D-image display unit configured to display a two-dimensional image, the 2D-image display unit provided opposite the light emitting surface; the light guide plate forms a plurality of the images; and the 2D-image display unit presents the two-dimensional image in accordance with the plurality of the images.

The above configuration allows the user to recognize what action is needed when the user attempts to provide input.

An input device according to one aspect of the present invention may be configured preferably so that the 2D-image display unit is configured to change the two-dimensional image presented.

The above configuration thus allows an input menu, which is an object for an input action from the user, to change as appropriate.

An input device according to one aspect of the present invention may be configured preferably so that when the sensor has detected the object, the sensor changes the region in which to detect the object to a region further away than the predetermined distance.

The above configuration allows for maintaining a state where the de sensor is detecting the object, even if the position of the object is unsteady after the input detection unit has detected the input from the user. Consequently, it is possible to prevent chattering.

An input device according to one aspect of the present invention may be configured preferably to further include a relay; and the input device controls the opening and closing of the relay in accordance with the detection state of the input from the user detected by the input detection unit.

The present invention is not limited to the above-described embodiments, and various modifications can be made within the scope of the claims, and the embodiments obtained by appropriately combining the technical means disclosed in the different embodiments are also included in the technical scope of the present invention.

### REFERENCE NUMERALS

1A-1F, 1Aa Input device
2 Position detection sensor (sensor)
3 Sound output unit (sound output device)
6 Ultrasound generation device (tactile stimulus device)
8 Sheet
11, 11A, 11B, 16, 61, 84 Light guide plate
11a, 16a, 61a, 84c Emission surface (light emitting surface)
11b Rear surface (opposing surface)
15 Opening
20 2D-image display unit
31 Input Detection Unit
32 Image control unit (notification unit)
33 Notification control unit (notification unit)
F Finger (object)
I, I1, I2 Stereoscopic image (image)
R Relay

1. An input device comprising: a light guide plate configured to direct light entering from a light source so that the light exits from a light emitting surface and forms an image in a space, the image an object for an input action from a user;
a sensor configured to detect an object employed by a user for the input action;
an input detection unit configured to detect an input from a user on the basis of a detection result from the sensor for the object; and
a notification unit configured to notify a user that the input was detected in response to the input detection unit having detected an input from a user; and
the sensor is placed in a space opposite the light emitting surface of the light guide plate.

2. The input device according to claim 1, wherein the light guide plate is transparent.

3. The input device according to claim 1, further comprising: a plurality of optical-path changing portions formed on the opposing surface that opposes the light emitting surface in the light guide plate, the optical-path changing portions having reflection surfaces for reflecting light guided through said light guide plate toward the light emitting surface; and
a surface density of the reflection surfaces to the opposing surface is less than or equal to 30%.

4. The input device according to claim 1, wherein the input device comprises a plurality of the light guide plates;
the plurality of light guide plates each forming a different one of the image in the space; and
the notification unit changing the images in response to the input being detected.

5. The input device according to claim 1, wherein the light guide plate forms an image at or near a location at which the sensor detects the object.

6. An input device comprising: a light guide plate configured to direct light entering from a light source so that the light exits from a light emitting surface and forms an image in a space, the image an object for an input action from a user;
a sensor configured to detect an object employed by a user for the input action;
an input detection unit configured to detect an input from a user on the basis of a detection result from the sensor for the object; and
a notification unit configured to notify a user that the input was detected in response to the input detection unit having detected an input from a user; and
the light guide plate forming the image at or near a location at which the sensor detects the object.

7. The input device according to claim 1, wherein the input detection unit detects the input in response to the sensor having detected that the object is positioned along the direction the input action is performed in a region a predetermined distance away from where the image is formed in a direction opposite the direction the input action is performed.

8. The input device according to claim 1, wherein the notification unit causes a display state of the image to vary in response to the input detection unit having detected an input from a user.

9. The input device according to claim 1, further comprising a sound output device serving as a notification unit for outputting a sound in response to the input detection unit having detected an input from a user.

10. The input device according to claim 1, further comprising a tactile stimulus device serving as a notification unit for remotely stimulating the sense of touch of a human body serving as the object.

11. The input device according to claim 1, wherein an opening is formed in the light guide plate for transmitting light for the sensor to detect the object; and
in response to the image being viewed from a direction perpendicular to the light emitting surface, an outline of the image and an outer circumference of the opening have the same or substantially the same shape.

12. The input device according to claim 1, further comprising a sheet formed opposite the light emitting surface of the light guide plate, the sheet having a design thereon corresponding to the image.

13. The input device according to claim 1, further comprising a 2D-image display unit configured to display a two-dimensional image, the 2D-image display unit provided opposite the light emitting surface; wherein
the light guide plate forms a plurality of the images; and
the 2D-image display unit presents the two-dimensional image in accordance with the plurality of the images.

14. The input device according to claim 13, wherein the 2D-image display unit is configured to change the two-dimensional image presented.

15. The input device according to claim 7, wherein in response to the sensor having detected the object, the sensor changes the region in which to detect the object to a region further away than the predetermined distance.

16. The input device according to claim 1, further comprising a relay; wherein
the input device controls the opening and closing of the relay in accordance with a detection state of the input from the user detected by the input detection unit.

17. The input device according to claim 2, further comprising: a plurality of optical-path changing portions formed on the opposing surface that opposes the light emitting surface in the light guide plate, the optical-path changing portions having reflection surfaces for reflecting light guided through said light guide plate toward the light emitting surface; and
a surface density of the reflection surfaces to the opposing surface is less than or equal to 30%.

18. The input device according to claim 2, wherein the input device comprises a plurality of the light guide plates;
the plurality of light guide plates each forming a different one of the image in the space; and
the notification unit changing the images in response to the input being detected.

19. The input device according to claim 2, wherein the light guide plate forms an image at or near a location at which the sensor detects the object.

20. The input device according to 2, wherein the input detection unit detects the input in response to the sensor having detected that the object is positioned along the direction the input action is performed in a region a predetermined distance away from where the image is formed in a direction opposite the direction the input action is performed.
